(19) United States
(12) Patent Application Publication
(10) Pub. No.: US 2011/0103966 A1
(43) Pub. Date: May 5, 2011

(54) FLOW BALANCING SLOT

(75) Inventors: Joshy John, Bangalore (IN); Rajnikumar Nandalal Suthar, Vadodara (IN); Rajaguru Nathan Krishnasamy, Sivakasi (IN)

(73) Assignee: GENERAL ELECTRIC COMPANY, Schenectady, NY (US)

(21) Appl. No.: 12/609,376

(22) Filed: Oct. 30, 2009

(51) Int. Cl. B64C 11/16

(52) U.S. Cl. 416/235

(57) ABSTRACT

A cover of an airfoil having opposing pressure and suction sides of a rotatable turbine stage to prevent fluid from crossover-flowing from a pressure side of a leading airfoil to a suction side of a trailing airfoil is provided. The cover includes pressure and suction side edge portions, one of which having a shape that is discontinuous relative to that of a complementary one of suction and pressure side edge portions of an aft cover of a corresponding one of a trailing and a leading airfoil, respectively.

### BACKGROUND OF THE INVENTION

The subject matter disclosed herein relates to a flow balancing slot.

Tip clearance losses in a turbine bucket typically constitute 20-25% of the total losses in the blade row. These losses generally occur due to high energy flow escaping through the clearance region without doing any useful work, mixing of tip leakage flow and passage flow downstream of the bucket and flow from the pressure surface of the airfoil crossing over to the suction surface. A lift force generated by the airfoil and a torque on the blade row are, thus, reduced.

The instance of flow crossover has been addressed by the installation of a cover on the bucket. The cover diverts flow away from the crossover region and decreases the losses associated with crossover flow.

The shape and size of the cover can influence the amount of the flow that is diverted and can thereby influence the level of the decreased losses. Unfortunately, mechanical constraints often require the cover to be scalloped and the scallop introduces an additional loss in the form of intrusion losses. Intrusion losses result from the in-out flow through the scallop and further increase downstream mixing losses. That is, in conventional bucket covers, flow leaving from an aft scallop region of the bucket cover re-enters the main flow and interacts with a horseshoe vortex propagating therein and, thus, increases a size and intensity of a flow-mixing loss region.

### BRIEF DESCRIPTION OF THE INVENTION

According to one aspect of the invention, a cover of an airfoil having opposing pressure and suction sides of a rotatable turbine stage to prevent fluid from crossover-flowing from a pressure side of a leading airfoil to a suction side of a trailing airfoil is provided. The cover includes pressure and suction side edge portions, one of which having a shape that is discontinuous relative to that of a complementary one of suction and pressure side edge portions of an aft cover of a corresponding one of a trailing and a leading airfoil, respectively.

According to another aspect of the invention, a rotatable turbine stage of a turbine engine is provided and includes a first aft cover of a first airfoil having opposing pressure and suction sides and a second aft cover of a second airfoil having opposing pressure and suction sides that immediately leads the first airfoil in a direction of turbine stage rotation. The first and second aft covers respectively include complementary pressure and suction side edge portions, one of which has a shape that is at least partially discontinuous relative to that of the other to prevent fluid from crossover-flowing from the pressure side of the second airfoil to the suction side of the first airfoil.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a turbine stage of a turbine engine;

FIG. 2 is an enlarged radial view of the turbine stage of FIG. 1;

FIGS. 3-7 are enlarged radial views of the turbine stage of FIG. 1 in accordance with various embodiments;

FIG. 8 is an enlarged radial view of the turbine stage of FIG. 1 in accordance with further embodiments; and

FIG. 9 is a perspective view of the turbine stage of FIG. 1 having non-axis-symmetric aft covers.

The detailed description explains embodiments of the invention, together with advantages and features without limitation, by way of example with reference to the drawings.

### DETAILED DESCRIPTION OF THE INVENTION

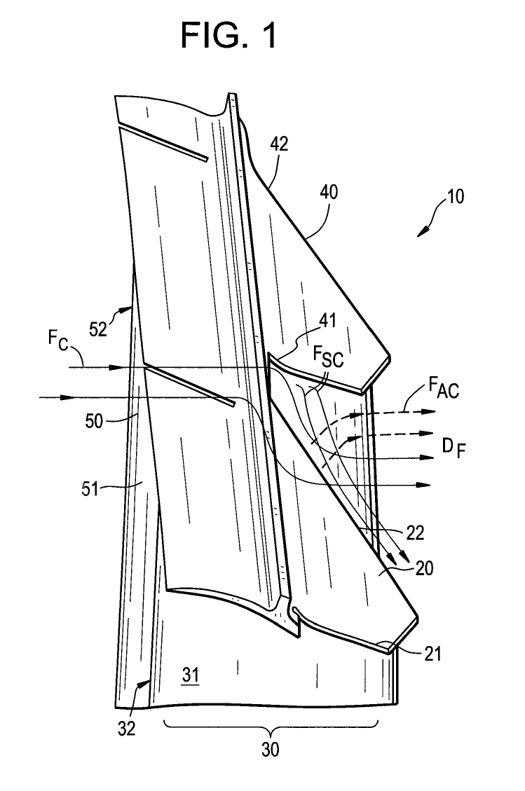

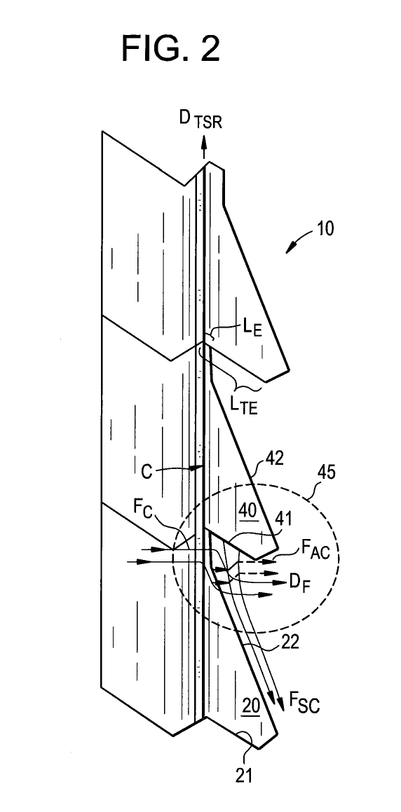

With reference to FIGS. 1 and 2, a rotatable turbine stage 10 of a turbine or gas turbine engine is provided. The turbine stage 10 may include a first aft cover 20 of a first airfoil 30 and a second aft cover 40 of a second airfoil 50. The first airfoil 30 includes a pressure side 31 and a suction side 32 and the second airfoil 50 includes a pressure side 51 and a suction side 52. The first airfoil 31 immediately trails the second airfoil 50 relative to a direction of turbine stage rotation D_{TSR} and at least one of the first and second aft covers 20 and 40 of the first and second airfoils 30 and 50 is formed to prevent fluid F_{SC}, such as passage flow, from crossover-flowing from a pressure side 51 of the second airfoil 50 to a suction side 32 of the first airfoil 30.

The first aft cover 20 includes a pressure side edge portion 21 and a suction side edge portion 22 arranged relative to the direction of turbine stage rotation D_{TSR} (see FIG. 2). Similarly, the second aft cover 40 includes a pressure side edge portion 41 and a suction side edge portion 42. One of the pressure side edge portions 21 and 41 and the suction side edge portions 22 and 42 has a shape that is at least partially discontinuous relative a shape of its complement. For example, as shown in FIG. 2, the suction side edge portion 22 of the first aft cover 20 has a shape that is discontinuous relative to a shape of the pressure side edge portion 41 of the second aft cover 40. This discontinuity forms a flow balancing slot 45 that prevents the fluid F_{SC} from crossover-flowing from a pressure side 51 of the second airfoil 50 to a suction side 32 of the first airfoil 30. The discontinuity further directs fluid F_{AC}, such as relatively high energy fluid leaving the first and second aft covers 20 and 40, to flow in a direction D_{F}, which is at least partially substantially transverse and radially outwards to the direction D_{TSR}.

The fluid F_{AC} directed by the flow balancing slot 45 may flow to a turbine casing of the turbine perimetrically surrounding the turbine stage 10. The flow balancing slot 45 may also align the fluid F_{AC} with the fluid F_{C} to reduce a size of a loss region and/or to provide a higher backpressure to the fluid F_{C} to reduce flows through a clearance region.

Simulation of turbine engines has indicated that the presence of the flow balancing slot 45 results in increased efficiency due to reductions of overall flow mixing loss regions and tip leakage flows. The flow balancing slot 45 also reduces an overall weight of a bucket cover and lengthens its lifetime. The use of the flow balancing slot 45 can be applied to all new turbines and as part of an upgrade package.

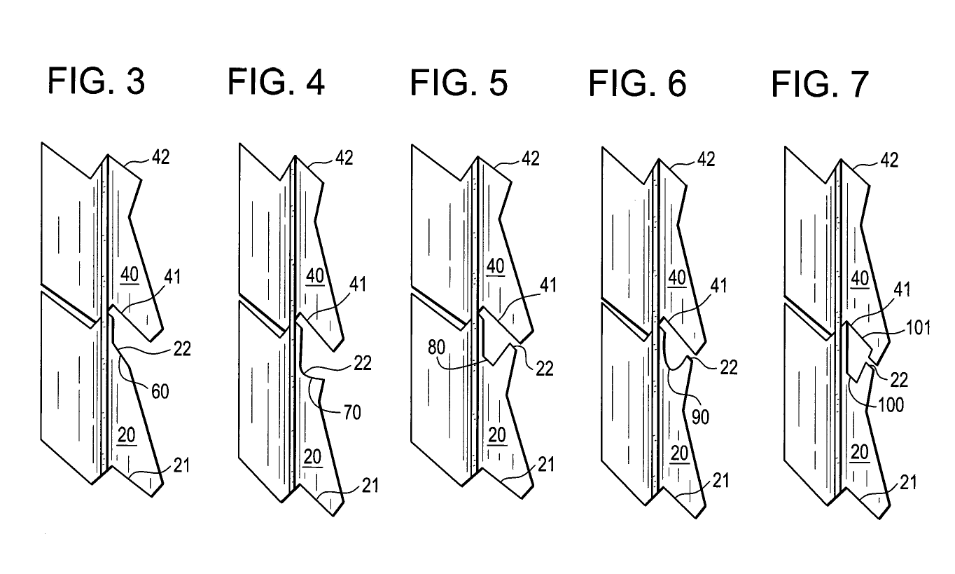

With reference to FIGS. 2-7, the discontinuity forming the flow balancing slot 45 may be located at the suction side edge portion 22. As shown in the examples of FIG. 2, the suction side edge portion 22 may have an axial length L_{E} which is shorter than an axial length L_{TE} of the pressure side edge portion 41 where L_{E} and L_{TE} are measured along a same line intersecting with an axial centerline C of the turbine stage 10. The axial discontinuity can result from the suction side edge portion 22 being formed with an angular shoulder 60 (see FIG. 3) including substantially straight edges, or with a concave rounded shoulder 70 (see FIG. 4) including a continuous rounded edge.

In alternate embodiments where the discontinuity is found in the suction side edge portion 22, as shown in the examples of FIGS. 5 and 6, the suction side edge portion 22 may be formed with an angular recess 80 (see FIG. 5) including substantially straight edges, or with a concave rounded recess 90 (see FIG. 6) including a continuous rounded edge.

With reference to FIG. 7, both the suction side edge portion 22 and the pressure side edge portion 41 may be the locations of discontinuities. That is, in the example of FIG. 7, both the suction side edge portion 22 and the pressure side edge portion 41 are formed with opposing recesses 100 and 101, respectively. Although illustrated as being angular recesses, it is understood that these recesses could also be concave rounded recesses.

It is further understood that the various embodiments shown in FIGS. 2-7 can be jointly or separately interchangeable with one another with departing from the scope of the various aspects of the invention.

In accordance with another aspect of the invention, a method of operating a turbine stage 10 of a turbine engine is provided and includes preventing a first fluid F_{SC} from crossover-flowing from, e.g., a pressure side 51 of a leading airfoil 50 to a suction side 32 of a trailing airfoil 30. The method further includes directing a second fluid F_{AC} leaving the aft cover 20, 40 to flow in a direction D_{F}. The direction D_{F} is at least initially substantially transverse to a direction of turbine stage rotation D_{TSR}. As described above, the preventing of the first fluid F_{SC} from crossover-flowing from the pressure side 51 of the leading airfoil 50 to the suction side 32 of the trailing airfoil 30 is achieved by a forming of a flow balancing slot 45 proximate to at least one of a suction side edge portion 22, 42 and a pressure side edge portion 21, 41 of the aft cover 20, 40.

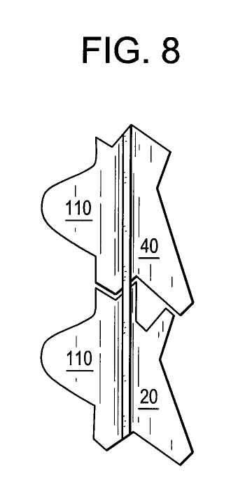

With reference to FIG. 8, it is understood that the configurations of the aft cover 20, 40 described above can be associated with varying configurations of the forward cover 110. For example, the forward cover 110 can be configured as shown in FIGS. 1-7 or scalloped as shown in FIG. 8.

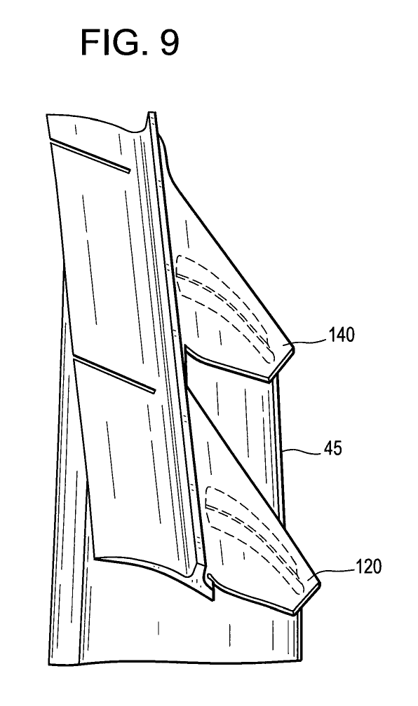

With reference to FIG. 9, it is further understood that the flow balancing slot 45 can be formed between aft covers 120 and 140 having non-axis-symmetric shroud shapes.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A cover of an airfoil having opposing pressure and suction sides of a rotatable turbine stage to prevent fluid from crossover-flowing from a pressure side of a leading airfoil to a suction side of a trailing airfoil, the cover comprising:
pressure and suction side edge portions, one of which having a shape that is discontinuous relative to that of a complementary one of suction and pressure side edge portions of an aft cover of a corresponding one of a trailing and a leading airfoil, respectively.

2. The cover according to claim 1, wherein the discontinuous one of the pressure and suction side edge portions directs fluid in a direction at least partially substantially transverse to a direction of the turbine stage rotation.

3. The cover according to claim 1, wherein the suction side edge portion is the discontinuous shape.

4. The cover according to claim 3, wherein the suction side edge portion is shorter in an axial direction than the complementary pressure side edge portion.

5. The cover according to claim 4, wherein the suction side edge portion is formed with an angular shoulder.

6. The cover according to claim 4, wherein the suction side edge portion is formed with a concave shoulder.

7. The cover according to claim 3, wherein the suction side edge portion is formed with an angular recess.

8. The cover according to claim 3, wherein the suction side edge portion is formed with a concave recess.

9. The cover according to claim 1, wherein the suction and pressure side edge portions are each formed with opposing recesses.

10. A rotatable turbine stage of a turbine engine, comprising:
a first aft cover of a first airfoil having opposing pressure and suction sides; and
a second aft cover of a second airfoil having opposing pressure and suction sides that immediately leads the first airfoil in a direction of turbine stage rotation,
the first and second aft covers respectively including complementary pressure and suction side edge portions, one of which has a shape that is at least partially discontinuous relative to that of the other to prevent fluid from crossover-flowing from the pressure side of the second airfoil to the suction side of the first airfoil.

11. The turbine stage according to claim 10, wherein the discontinuous one of the pressure and suction side edge portions directs fluid in a direction at least partially substantially transverse to a direction of the turbine stage rotation.

12. The turbine stage according to claim 10, wherein the suction side edge portion comprises the discontinuous shape.

13. The turbine stage according to claim 12, wherein the suction side edge portion is shorter in an axial direction than the pressure side edge portion.

14. The turbine stage according to claim 13, wherein the suction side edge portion is formed with an angular shoulder.

15. The turbine stage according to claim 13, wherein the suction side edge portion is formed with a concave shoulder.

16. The turbine stage according to claim 12, wherein the suction side edge portion is formed with an angular recess.

17. The turbine stage according to claim 12, wherein the suction side edge portion is formed with a concave recess.

18. The turbine stage according to claim 10, wherein the suction and pressure side edge portions are each formed with opposing recesses.

19. The turbine stage according to claim 10, further comprising a scalloped cover of at least one of the first and the second airfoils.

20. The turbine stage according to claim 10, wherein at least one of the first and second aft covers has a non-axis-symmetric shape.
